(19) United States
(12) Patent Application Publication
(10) Pub. No.: US 2026/0187994 A1
(43) Pub. Date: Jul. 2, 2026

(54) METHOD AND SYSTEM FOR EXPLAINABLE IMAGE CLASSIFICATION

(71) Applicant: TECHNION RESEARCH & DEVELOPMENT FOUNDATION LIMITED, Haifa (IL)

(72) Inventors: Guy GILBOA, Haifa (IL); Elnatan KADAR, Haifa (IL); Meir Yossef LEVI, Haifa (IL)

(21) Appl. No.: 19/434,430

(22) Filed: Dec. 29, 2025

Related U.S. Application Data
(60) Provisional application No. 63/739,574, filed on Dec. 29, 2024.

(51) Int. Cl. G06V 10/82; G06T 11/10; G06T 11/60

(52) U.S. Cl. CPC G06V 10/82; G06T 11/10; G06T 11/60

(57) ABSTRACT

A system and method of explainable classification of a target image by at least one processor may include: applying a pretrained classifier on the target image to predict a class according to a classification category; generating a style vector based on the predicted class; applying a first generative model on the target image and style vector to generate an image component that is class-distinct in relation to the predicted class; applying one or more second generative models on the target image and style vector to generate one or more respective image components that are class-agnostic in relation to the predicted class; and presenting the class-distinct image component as explanatory data for the predicted class, wherein the class-distinct image component and the class-agnostic image components are adapted to be additively combined to obtain a reproduction of the target image.

### CROSS-REFERENCE TO RELATED APPLICATIONS

This application claims the benefit of priority of U.S. Application No. 63/739,574, titled “METHOD AND SYSTEM FOR EXPLAINABLE IMAGE CLASSIFICATION”, filed Dec. 29 2024, which is hereby incorporated by reference in its entirety.

### FIELD OF INVENTION

The present invention relates generally to image analysis. More specifically, the present invention relates to explainable image classification.

### BACKGROUND

Understanding the reasoning behind neural network classifications is important for improving the classification process, aiding in debugging and validation, and providing additional informative output for users. Explainable artificial intelligence (XAI) research has focused on methods to make neural network decisions more transparent.

The most common approach in image classification is through generation of explanation heatmaps. These heatmaps provide a per-pixel indication of the relevance of each pixel to the final classification decision of the network, with higher values showing greater relevance. These maps may be at a lower resolution, where visualization is done by up-sampling, or by using super-pixels. The heatmaps themselves do not resemble actual images, and to understand the role of the pixels in a heatmap, common practices include showing the input image and the heatmap side by side, overlaying the heatmap on the image, or showing an image where the brightness of the pixels is weighted by the normalized heatmap.

Heatmap-based visual explanation methods may be adequate when the explanation is spatially sparse, that is, when there are just a few small regions in the image which contribute mostly to the classification. However, there are many classification problems in which the explanations are dense in the image domain. In such scenarios, traditional heatmap-based methods may be limited, particularly where pixels contain both class-specific and neutral information.

For example, heatmap-based methods may not provide sufficient explanatory information in scenarios where: (1) an object to be classified spans a large portion of the image domain and contains many diverse features, all contributing to the final classification; (2) a main feature contributing to the classification is color change, which appears throughout the image; or (3) the class distinction is based on some global disturbance or statistical change, which spans the entire image domain.

In such cases, heatmaps may either focus too narrowly on a small portion of dominant features or show large uniform areas, making it difficult to understand the network's decision.

Beyond the limitations related to dense explanations, currently available XAI methods may suffer from additional drawbacks. Resolution limitations may hinder fine detail distinction, usually caused by calculating importance in spatially coarse internal layers. Computational complexity may result in extended runtime or high memory consumption due to gradient or attribution calculations across multiple layers or using numerous perturbation iterations. Architectural constraints may be imposed by certain solutions, such as requiring specific activation layers or even a dedicated architecture designed solely for XAI. Additionally, currently available solutions typically produce single-channel, grayscale images representing the importance of each pixel, lacking color distinction or multi-channel data in general. This can lead to inadequate explanations in scenarios where color or texture information is relevant to the classification.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

To address these limitations, embodiments of the present invention may employ a decomposition-based, explainable AI (DXAI) process. Instead of using heatmaps, embodiments of the invention may decompose the image of interest into class-agnostic and class-distinct images. Following a signal processing paradigm of analysis and synthesis, the original image may be represented as the sum of the decomposed parts. The class-agnostic image may ideally be composed of all image features which do not possess class information, while the class-distinct image may be its complementary, holding the discriminative information that allows the classifier to obtain distinction from other classes.

Embodiments of the invention may thereby provide more informative visualization to explain image classification, especially in scenarios where attributes are dense, global, and/or additive in nature, for instance when colors or textures are relevant for class distinction.

Embodiments of the invention may employ generative models and style transfer techniques to achieve high-resolution, dense, multi-channel explanations.

Additionally, embodiments of the invention may not require gradient computations to produce class-agnostic and class-distinct explanations at inference time, and may therefore be suitable for real-time applications.

Currently available processes for visually explaining image classification may highlight areas according to their contribution to an image's classification.

One approach for image classification explainability includes backpropagation-based methods, that involve tracing the classifier's solution backward through the model's layers, to measure contribution of each layer to the subsequent one. Such methods encompass computationally intensive, gradient-based and attribution-based techniques. Embodiments of the invention may be devoid of such computations during inference, and may therefore provide an improvement over currently available computational technology.

Another approach for image classification explainability includes perturbation-based methods, which are designed to evaluate an impact of changes in the input on the output classification: Changes leading to strong output variations may be deemed important. Other methods may be based on estimating the uncertainty in the solution, and use this estimation to produce explanations for data classification.

Another example of currently available methods includes attention-based methods, which are designed to identify relationships within the input, to discern important image characteristics. Such methods often require specific classifier architectures.

Generative models are also used to explain differences between classes. Many of the methods aim at providing counterfactual explanations. However, it appears to be difficult to use these explanations in order to produce a map of clearly highlighted differences.

Currently available XAI methods typically suffer from at least one of the following drawbacks:
Resolution: Low resolution may hinder fine detail distinction, usually caused by calculating importance in spatially coarse internal layers;
Computational complexity: Extended runtime or high memory consumption due to gradient or attribution calculations across multiple layers or using numerous perturbation iterations;
Architecture: Certain solutions may impose architectural constraints, such as specific activation layers or even a dedicated architecture designed solely for XAI.
Single channel: Currently available solutions typically produce grayscale images representing the importance of each pixel, lacking color distinction (multi-channel data in general). This can lead to inadequate explanations, as explained herein.

Embodiments of the invention may be adapted to overcome these drawbacks, as elaborated herein. The foregoing general description of the illustrative embodiments and the following detailed description thereof are merely exemplary aspects of the teachings of this disclosure and are not restrictive.

Embodiments of the invention may include a method of explainable classification of target images, by at least one processor. According to some embodiments, the at least one processor may be configured to apply a pretrained classifier on a target image, to predict a class of the target image according to a classification category. The at least one processor may generate a style vector based on the predicted class, and apply a first generative model on the target image and the style vector, to generate an image component that is class-distinct in relation to the predicted class.

The at least one processor may further apply one or more second generative models on the target image and the style vector, to generate one or more respective image components that are class-agnostic in relation to the predicted class. The class-distinct image component and the one or more class-agnostic image components may be adapted to be additively combined, to obtain a reproduction of the target image. The at least one processor may present at least one of the class-distinct image component and class-agnostic image component as explanatory data for the predicted class as an intuitive explanation of the image classification, for human operators.

According to some embodiments, the at least one processor may be configured to train the first generative model and the one or more second generative models using a combination of loss function values. The combination of loss function values may include, for example, a value of classification loss, adapted to align the reproduced target image with the classifier's predictions, and a value of reconstruction loss, adapted to ensure the reproduced target image approximates the target image.

Additionally, or alternatively, the combination of loss function values may include a value of adversarial loss, adapted to ensure generation of realistic image components by the generative models.

Additionally, or alternatively, the combination of loss function values may include a value of class-distinct reconstruction loss, adapted to enhance reconstruction quality of the reproduced target image in regions with significant class distinctions.

According to some embodiments, the at least one processor may train the first generative model and one or more second generative models by receiving a batch of training images.

For example, the at least one processor may be configured to randomly select a weight vector α, having entries corresponding to respective generative models of the one or more second generative models. For one or more (e.g., each) training images in the batch, the at least one processor may be configured to calculate a respective pair of interim images based on the weight vector α, and calculate the combination of loss function values based on the pairs of interim images. The at least one processor may subsequently modify weights of at least one of the first generative model and the one or more second generative models based on the combination of loss function values.

As explained herein, a first interim image of the pair of interim images may represent a reproduction of the respective training image that emphasizes the predicted class, and a second interim image of the pair of interim images may represent reproduction of the respective training image that emphasizes an alternative class, different from the predicted class.

The at least one processor may calculate the first interim image as a weighted sum of (a) a class-distinct image component of the respective training image, representing the predicted class, generated by the first generative model, (b) class-agnostic image components of the respective training image, generated by the one or more second generative models, representing the predicted class, weighted according to the weight vector α, and (c) class-agnostic image components of the respective training image, generated by the one or more second generative models, representing the alternative class, weighted according to (1−α).

Additionally, or alternatively, the at least one processor may calculate the second interim image as a weighted sum of (a) a class-distinct image component of the respective training image, representing the alternative class, generated by the first generative model, (b) class-agnostic image components of the respective training image, generated by the one or more second generative models, representing the alternative class, weighted according to the weight vector α, and (c) class-agnostic image components of the respective training image, generated by the one or more second generative models, representing the predicted class, weighted according to (1−α).

According to some embodiments, training the first generative model and one or more second generative models may include encouraging the one or more second generative models to generate substantially identical image components for both the predicted class and the alternative class, thereby isolating distinctive features between the predicted class and the alternative class to the first generative model.

The at least one processor may be configured to obtain a mapping network, configured to encode class-specific characteristics as style representation vectors. The at least one processor may apply the mapping network on the predicted class. The at least one processor may generate the style vector based on output of the mapping network.

According to some embodiments, the adversarial loss may be generated by employing a multi-head discriminator. The multi-head discriminator may be configured to receive generated image components from the first generative model and the one or more second generative models. The multi-head discriminator may produce, for each received image component, a vector having a length corresponding to a number of classes, where each element may represent an authenticity grade indicating whether the image component is real or fake with respect to a respective class. The multi-head discriminator may be configured to calculate the adversarial loss based on the authenticity grades to encourage the generative models to produce realistic image components that resemble authentic images for their respective classes.

According to some embodiments, the at least one processor may calculate the class-distinct reconstruction loss by generating a mask consisting of pixels where an absolute value of the class-distinct image component exceeds a mean absolute value of the class-distinct image component. The at least one processor may compute the class-distinct reconstruction loss based on a distance measure between (i) an element-wise product of the target image and the mask, and (ii) an element-wise product of the reproduced target image and the mask.

According to some embodiments, system 10 may present the class-distinct image component as explanatory data for example by: displaying the class-distinct image component separately from the target image to highlight features that contribute to the predicted class; overlaying the class-distinct image component on the target image to show spatial correspondence between distinctive features and the original image; displaying the class-distinct image component alongside the one or more class-agnostic image components to demonstrate the decomposition of the target image; providing the class-distinct image component as a visual explanation that shows which image features led to the predicted class; and outputting the class-distinct image component in a format suitable for user interpretation of the classification decision.

As explained herein, the at least one processor may pretrain the classifier by receiving a labeled dataset including training images and corresponding class labels and processing the training images through the classifier to obtain predicted class probabilities. The at least one processor may train the classifier by calculating a classification loss based on the predicted class probabilities and the corresponding class labels, and subsequently adjusting weights of the classifier based on the classification loss.

Embodiments of the invention may include a system for explainable classification of a target image. Embodiments of the system may include a non-transitory memory device, wherein modules of instruction code may be stored. The system may further include at least one processor associated with the memory device, and configured to execute the modules of instruction code.

Upon execution of said modules of instruction code, the at least one processor may be configured to apply a pretrained classifier on the target image, to predict a class of the target image according to a classification category. The at least one processor may be further configured to generate a style vector based on the predicted class. The at least one processor may be configured to apply a first generative model on the target image and the style vector, to generate an image component that is class-distinct in relation to the predicted class. The at least one processor may be further configured to apply one or more second generative models on the target image and the style vector, to generate one or more respective image components that are class-agnostic in relation to the predicted class. The at least one processor may be configured to present the class-distinct image component as explanatory data for the predicted class. The class-distinct image component and the one or more class-agnostic image components may be adapted to be additively combined, to obtain a reproduction of the target image.

### BRIEF DESCRIPTION OF FIGURES

The patent or application file contains at least one drawing executed in color. Copies of this patent or patent application publication with color drawing(s) will be provided by the Office upon request and payment of the necessary fee.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for providing explainable image classification, according to some embodiments; and

FIGS. 2A and 2B are block diagrams, depicting examples of a system for explainable image classification, according to some embodiments of the invention;

FIG. 3 is a table of images showing examples of producing explainable image classifications, by embodiments of the invention, and by other, currently available methods;

FIGS. 4A and 4B are tables of images showing examples of producing explainable image classifications by embodiments of the invention, using class-distinctive and class-agnostic images, alongside other, currently available methods of explainable image classifications; and

FIG. 5 is a flow diagram, depicting a method of providing explainable image classification, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

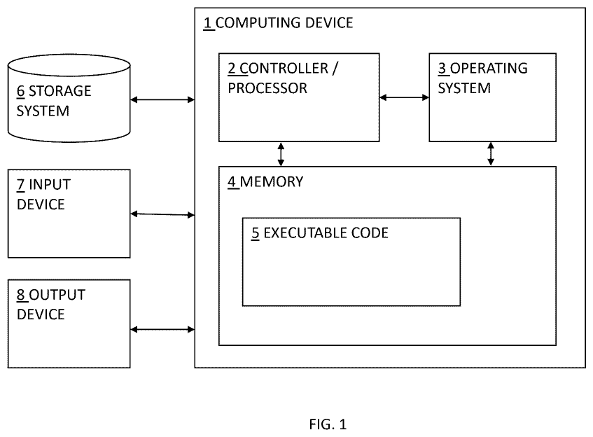

Reference is now made to FIG. 1, which is a block diagram depicting a computing device 1, which may be included within an embodiment of a system 10, according to some embodiments of the invention.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may provide explainable image classification as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to an image of interest may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

The term neural network (NN) or artificial neural network (ANN), e.g., a neural network implementing a machine learning (ML) or artificial intelligence (AI) function, may be used herein to refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. At least one processor (e.g., processor 2 of FIG. 1) such as one or more CPUs or graphics processing units (GPUs), or a dedicated hardware device may perform the relevant calculations.

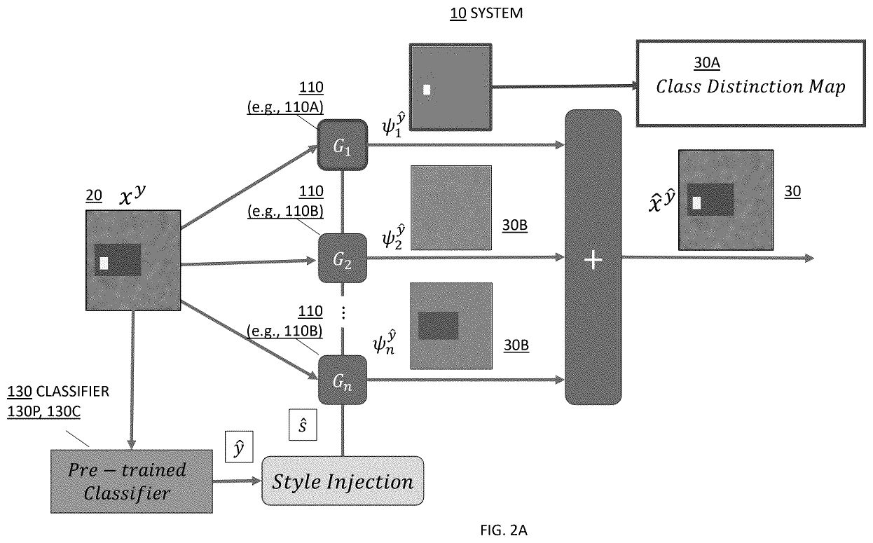

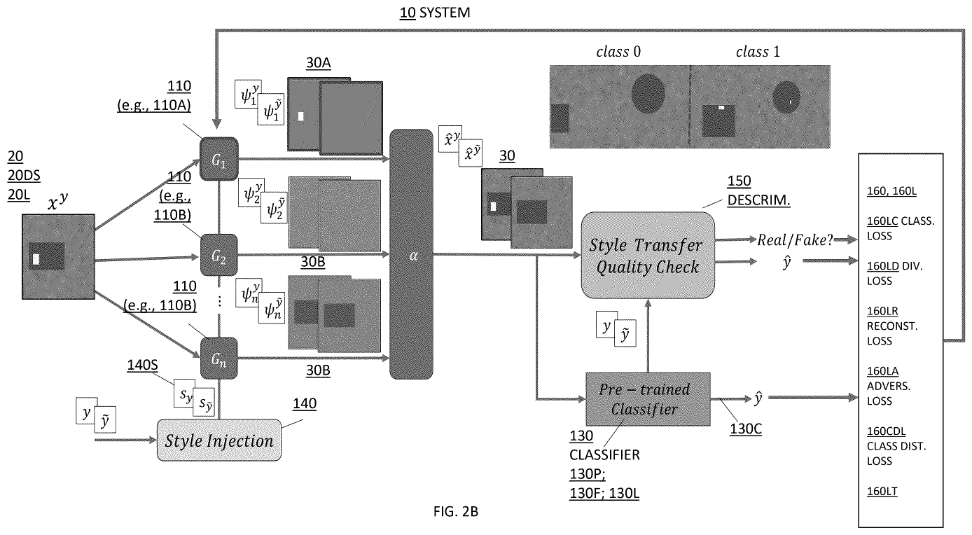

Reference is now made to FIGS. 2A and 2B which depict a system 10 for explainable image classification, by a classifier 130, according to some embodiments of the invention.

FIG. 2A depicts an inference stage of system 10, during which an image of interest 20 (also denoted herein as x^{y}) may be processed to generate a class-distinct image (also referred to as a “distinction map”) 30, denoted herein as \hat{x}^{y}.

FIG. 2B depicts a training stage of system 10, during which instances of incoming images 20 (e.g., pertaining to a training dataset 20DS) are processed and utilized to train one or more elements of system 10 to generate respective class-distinct images 30 \hat{x}^{y}. As explained herein, class-distinct images 30 may be used, or presented to explain classifications of classifier 130.

According to some embodiments of the invention, system 10 may be implemented as a software module, a hardware module, or any combination thereof. For example, system 10 may be, or may include a computing device such as element 1 of FIG. 1, and may be adapted to execute one or more modules of executable code (e.g., element 5 of FIG. 1) to provide explainable image classification e.g., in the form of class-distinct images 30, as further described herein.

As shown in FIGS. 2A and 2B, arrows may represent flow of one or more data elements to and from system 10 and/or among modules or elements of system 10. Some arrows have been omitted in FIGS. 2A and 2B for the purpose of clarity.

As explained herein, system 10 may be configured to partition an image of interest 20 (x^{y}) to two separate image components: A first image component may be a data element (e.g., a first image) that is neutral to the classifier 130. This image component may be referred to herein as “agnostic”, or “classification-agnostic” to classifier 130, and may be denoted as element 30B or \hat{x}^{ŷ}. A second image component may be data (e.g., a second image) that may be indicative of the classification. This image component may be referred to herein as “distinct”, or “classification-distinct” to classifier 130, and may be denoted as element 30A or \hat{x}^{y}.

Pertaining to the example of FIG. 2B, system 10 may be trained to classify input images 20 (e.g., pertaining to a training dataset 20DS) based on a specific classification category, such as whether the images include a little white rectangle or not. System 10 may further generate class-distinct 30A and/or class agnostic 30B images, to explain the outcome classification.

As shown in FIGS. 2A and 2B, system 10 may include generative models 110 (e.g., 110A, 110B also denoted herein as elements G₁, G₂, . . . , G_{N}). System 10 may utilize generative model(s) 110A to generate class-distinct images 30A, which hold discriminative information, allowing classifier 130 to obtain distinction among classes in a classification category of interest. In this case, the classes may be binary, e.g., depicting/not depicting a white rectangle.

System 10 may further utilize generative model(s) 110B to generate class-agnostic images 30B, which ideally do not possess class information in the classification category of interest. In this example, class-agnostic images 30B may be discriminative in relation to classification categories pertaining to other classification categories (e.g., characterizing the image background, or the large grey rectangle), but are nevertheless agnostic, or non-discriminative in relation to the classification category of interest (e.g., existence of a small white rectangle in image 20).

System 10 may utilize generative modules G₁, G₂, . . . , G_{N} such that the sum, or superposition image (denoted 30) of the generated class-distinct images 30A and class-agnostic images 30B may be a reconstructed version of input image 20.

The following discussion provides basic notations, assuming a multiclass supervised learning setting. Let X be the space of input images, and x∈X be an input image belonging to one of c classes.

An additive composition of input image 20 x is assumed, as in Eq. 1 below:

$$x = {ψ}_{Agnostic} + {ψ}_{Distinct} \qquad Eq . 1$$

where ψ_{Agnostic} (also denoted 30B) is the class-agnostic image component, which ideally does not entail information about the classification category of interest, and ψ_{Distinct} (also denoted 30A) is the class-distinct image component which holds the discriminative information, allowing classifier 130 to obtain distinction among classes of the classification category.

Let y∈Y be a class label y∈{0, c−1} of a specific classification category. The training set 20DS may include M pairs (xᵢ, yᵢ)∈X×Y, where i=1, . . . ,M. Let x^{y} denote an image x belonging to class y. Image classifier 130 (also denoted herein as classifier ‘C’) may be configured to predict a class probability vector p (also denoted 130P), which may include a plurality of entries or features 130F. According to some embodiments, system 10 may be configured to analyze probability vector p (130P), to identify and extract relevant features 130F that contribute to the predicted classification 130C by classifier 130. In the example of FIG. 2B, the extracted features 130F may be those which contribute to the classifier's prediction 130C of whether or not instant input image 20 depicts a white rectangle.

According to some embodiments, system 10 may use style transfer based on generative AI to accomplish this task. As explained herein, this way of explaining classifications may introduce new computational and visualization tools, which are more intuitive and informative in relation to currently available systems.

Embodiments of the invention may aim to have a reference image, which is neutral in terms of classification for a given classifier 130 and classification category, using the following definitions.

### Definition 1 (Class Agnostic)

For an image ψ∈X, given c classes of images and a classifier C (130) providing a vector p(ψ)∈R^{c} of class probabilities, w may be regarded as class-agnostic if the probability is substantially uniform, that is pᵢ (ψ)=1/c, ∀i=1, . . . c, where pᵢ is the i's entry of p.

We denote by X_{A} ⊂X the space of all ψ∈X which are class agnostic, as defined above. Given an image x∈X with class probability vector p (x), and a classifier C (130), we would like to solve the following minimization problem of Eq. 2, below:

$${min}_{ψ ∈ {x}_{A}} d ( x , ψ ) \qquad Eq . 2$$

where d(⋅, ⋅) is a predetermined distance measure. For example, system 10 may use a combination of L¹ and L² norms for this distance.

Eq. (2) is also referred to herein as the DXAI (decomposition-based XAI) problem.

### Definition 2 (Class Distinct/Agnostic Parts of Image x (20))

Let x∈X be an image with class probability vector p(x) provided by classifier C (130). Let ψ* be a minimizer of Eq. 2. Then ψ_{Agnostic}=ψ* is a class agnostic image component of image x and ψ_{Distinct}=X−ψ* is a class distinct image component.

In words, for a given image x, system 10 may find the closest image (with respect to distance metried) which is neutral, or agnostic in relation to the classification category of interest. System 10 may provide the difference between x and this neutral image as a class-distinct image component to explain the probability vector p(x) (130P) and the reason, according to the classifier 130, why it deviates from neutrality.

The pair {ψ_{Agnostic}, ψ_{Distinct}} may provide detailed and dense class explanation as class-agnostic and class-distinct image components. Obtaining an approximate agnostic image component may be computed for each image directly using optimization techniques. For example, by minimizing a loss that requires minimal distance in terms of Kullback-Leibler (KL) divergence between the distribution generated by classifier C (130) and a uniform distribution. However, the class-distinct image component may not be semantically viable, and may mostly be based on out-of-distribution features which may resemble noise.

Obtaining a solution that captures semantic characteristics is more challenging. System 10 may solve this by using generative models 110 (e.g., 110A, 110B), also denoted herein as elements G, to generate semantically meaningful image components.

Given an image x (20) classified to class y by classifier 130 C, system 10 may approximate a pair of image components {ψ_{Agnostic}, ψ_{Distinct}}, and may use a set of generative models 110 such as style-transfer Generative Artificial Networks (GANs) for the decomposition.

The inventors studied a naive approach to obtain a decomposition from a heatmap H. This approach included normalizing the heatmap to obtain a weight w for each pixel, where w=H/max(H)∈[0,1], and defining for an image x, ψ_{Distinct}=w⋅x and ψ_{Agnostic}=(1−w)·x. However, the inventors found that such trivial manipulations of the heatmap would not generate high quality class-distinct components. The inventors found that the decomposition approach described herein typically outperforms such heatmap-based decompositions by a considerable margin.

System 10 may leverage style transfer as a tool for discerning inter-class differences, and generating class-explanations.

As shown in FIGS. 2A and 2B, system 10 may include a style injection module 140, adapted to produce a style vector 140S (also denoted herein as Sy), according to a predetermined classification y. Style vector 140S may encode class-specific characteristics associated with a given class. In some embodiments, style vector 140S may be generated by a dedicated mapping network. The dedicated mapping network may take a specific class (y) as input, and produce the corresponding style representation vector 140S (y) therefrom.

According to some embodiments, system 10 may obtain a mapping network, configured to encode class-specific characteristics as style representation vectors. System 10 may apply the mapping network on the predicted class, and generate the style vector 140S based on output of the mapping network.

System 10 may leverage style transfer as a tool for discerning inter-class differences and generating class-explanations. During training, system 10 may aim to transform an image 20 from class y into an image representative of a target class \tilde{y}. Successful style transfer may require the identification and modification of distinct class-specific characteristics. Style transfer may be accomplished by using the style vector s_{\grave{y}} associated with class \grave{y} in the generators. That is,

$${ψ}_{i}^{ý} = {G}_{i} ( {x}^{y} , {s}_{ý} ) .$$

During inference, the classifier 130 may predict the class 130C of an input image as ŷ. The style injection module 140 may then generate a style vector 140S (s_{\grave{y}}) based on the predicted class ŷ. This style vector 140S may be provided to the generators 110 along with the input image 20, to guide the generators 110 in producing the class-distinct 30A and class-agnostic 30B decompositions that explain the predicted classification 130C.

Given an image x of class y (i.e., x^{y}), system 10 may approximate it by the following decomposition into n components (branches), as shown in Eq. 3 below:

$${\hat{x}}^{y} = {ψ}_{1}^{y} + {\sum }_{i = 2}^{n} {ψ}_{i}^{y} \qquad Eq . 3$$

where:
a. \hat{x}^{y}≈x^{y}: generated output image 30 under assumption of classification y is a reconstructed version of input image 20 with the same assumed classification, and
b. ψ^{y}ᵢ=Gᵢ (x^{y}, s_{y}): image components ψ^{y}ᵢ are generated by respective style transfer generator Gi (110), given style vector Sy.
   The following values for the class-agnostic image component ψ_{Agnostic} and the class-distinct image component ψ_{Distinct} may be assigned as in Eq. 4, below:

$${ψ}_{Distinct} = {ψ}_{1}^{y} ; {ψ}_{Agnostic} = {\sum }_{i = 2}^{n} {ψ}_{i}^{y} . \qquad Eq . 4$$

System 10 may aim to transform an image from class y into an image representative of target class \grave{y}. Successful style transfer may requires the identification and modification of distinct class-specific characteristics. Style transfer may be accomplished by using the style vector s_{\tilde{ } y} associated with class ^{\tilde{ }}y in the generators. That is, the image component

$${ψ}_{i}^{ý} = {G}_{i} ( {x}^{y} , {s}_{ý} ) .$$

In addition, system 10 may incorporate a multi-head discriminator 150 (also denoted herein as ‘D’). Discriminator 150 may be a versatile component, that may serve a dual role:

Discriminator 150 may take an image as input, an produce a vector whose length corresponds to the number of classes. Each element in this vector may be regarded as a “grade”, reflecting the authenticity of the input image concerning the class it represents.

Additionally, beyond its role as a discriminator, D 150 may also serve as a classifier, effectively classifying the input image 20 by selecting the class with the highest “grade” using argmax of its output vector.

Additionally, as explained herein, system 10 may include a pre-trained classifier C 130 for which DXAI is computed. In this context, generators 110 may aim to deceive the classifier 130 by aligning their outputs with the intended class representation. Here, the multi-head discriminator 150 may evaluate the extent to which the generators successfully mislead the pre-trained classifier 130 while ensuring the overall quality and realism of the generated images 30.

According to some embodiments, the generative models 110 described herein may be implemented using various architectures. While the examples described herein utilize a GAN-based implementation with style-transfer generators 110, the decomposition-based explainable AI concept may not be limited to such implementation. For example, diffusion-type generative models may be used to implement the style transfer generators 110. In such implementations, the adversarial loss function may be modified or omitted as appropriate for the diffusion model architecture.

According to some embodiments, the classifier 130 may be pretrained prior to integration into system 10. Additionally, or alternatively, system 10 (e.g., processor 2) may be configured to train classifier 130 as follows:

System 10 may receive a labeled dataset 20DS that includes training images 20 and corresponding class labels 20L. The classifier 130 may process the training images 20 to obtain a predicted vector of class probabilities 130P. A classification loss 130L may be calculated based on the predicted class probabilities 130P and the corresponding class labels 20L. Weights of the classifier 130 may be adjusted based on the classification loss 130L. Once pretrained, classifier 130 may be integrated into system 10 for use in the DXAI process as elaborated herein.

In the example of FIGS. 2A and 2B, classifier 130 may be utilized to classify images x 20 according to the classification category of existence or absence of a white rectangle. As shown in these images, the class distinct part is depicted in a first branch (top, in red), whereas the class agnostic components, which belong to both classes, are generated by subsequent branches.

According to some embodiments, the training process may include two main components: an α-blending generation mechanism and loss function optimization. The α-blending mechanism may be a generation mechanism that controls how training images are produced, operating before the loss functions are calculated. After images are generated using α-blending, the loss functions may be calculated and may provide feedback to adjust the weights of the generators.

According to some embodiments, in order for the first channel to contain class distinct information, generators 110 may be trained using an a-blended generation mechanism: For each batch, a random vector α of length n−1 may be drawn (e.g., randomly), where each element is uniformly distributed in the range [0, 1]. Two images are then generated during training as follows, based on Eq. 5 below:

$${\hat{x}}^{y} = {ψ}_{1}^{y} + {\sum }_{i = 2}^{n} {α}_{i - 1} {ψ}_{i}^{y} + {\sum }_{i = 2}^{n} ( 1 - {α}_{i - 1} ) {ψ}_{i}^{\tilde{y}} \qquad Eq . 5$$

$${\hat{x}}^{\tilde{y}} = {ψ}_{1}^{\tilde{y}} + {\sum }_{i = 2}^{n} {α}_{i - 1} {ψ}_{i}^{\tilde{y}} + {\sum }_{i = 2}^{n} ( 1 - {α}_{i - 1} ) {ψ}_{i}^{y}$$

where y is the class of the input image, \grave{y} represents a random alternative class \grave{y}≠y, \hat{x}^{y} represents reconstructed image 30 given class y (e.g., depicting a white rectangle), and \grave{x}^{\grave{y}} represents reconstructed image 30 given class \grave{y} (e.g., not depicting a white rectangle).

Embodiments of the invention may encourage generators 110 to generate substantially identical image components for both classes in the sum

$${ψ}_{i}^{y} \approx {ψ}_{i}^{{y}^{′}} , i = 2 , … , n$$

(e.g., 30B identical between classes \grave{y} and y) and thus to isolate the distinction between the classes to the class-distinct image component ψ₁ (e.g., image component 30A) of top branch generator G₁ 110A. In the ideal case, where the image components in the sum are identical, and the distinction is only in ψ₁ (in image 30A), Eq. 5 converges to Eq. 3. The proposed α-blending method allows a stable and effective training.

It may be noted that other alternatives, such as attempting to use norm-based losses, e.g. ∥ψ^{y}ᵢ-ψ^{\tilde{ }y}ᵢ∥, may yield degenerate solutions, with image component ψ^{y}ᵢ≈0.

System 10 may include a loss computation module 160, configured to calculate values of one or more loss functions, including for example, a classification loss value 160LC, a reconstruction loss value 160LR, an adversarial loss value 160LA, and a class-distinct reconstruction loss value 160CDL.

During a training stage, the calculated loss function values may be provided as feedback to generators 110. System 10 may adjust weights of generators 110 to minimize these loss function values, thereby optimizing explainability of predicted classification 130C.

Classification loss 160LC: Since a pre-trained classifier 130 may be integrated into system 10, there may be no need to further train it on authentic images. Instead, embodiments of the invention may leverage its classification and attempt to explain it. System 10 may enable generators 110 to produce images that correspond to the classifier's predictions through the loss function of Eq. 6, below:

$${L}_{class - fake} = CrossEntropy ( C ( G ( {x}^{y} , {s}_{{y}_{trg}} ) ) , {y}_{trg} ) \qquad Eq . 6$$

where L_{class-fake} is the classification loss (160LC), C is the predicted classification by classifier 130, Y_{trg} is some target class, and G(X^{y}, Sy_{trg}) is an image X, which is classified as y, generated by generator G given style vector Sy_{trg}.

Divergence loss 160LD: In the GAN-based model depicted in the example of FIGS. 2A and 2B, discriminator 150 may also be used as a classifier, in addition to its classical role. This is in order to distinguish between real and fake images in each class. System 10 may use a Kullback-Leibler divergence loss 160LD between the classification output of the discriminator 150 and that of the pre-trained classifier C 130. This may promote having a high value in the discriminator output only for images which appear real, and fit the correct class.

Reconstruction loss 160LR: Generated image \hat{x}^{y} (e.g., 30, classified as y, depicting a white rectangle) may approximate x (see Eq. 3 and Eq. 5). To obtain a good approximation, \hat{x}^{y}≈x, system 10 may use a fidelity measure, based on L₁ and L₂ norms, as elaborated in Eq. 7, below:

$$d ( u , v ) = {‖ u - v ‖}_{{L}^{1}} + {‖ u - v ‖}_{{L}^{2}} \qquad Eq . 7$$

Thereby penalizing small and large changes. The style transferred class may be similar to the input image. Thus, the reconstruction loss may be with respect to the generated images of both classes, as in Eq. 8 below:

$${L}_{rec} = d ( x , {\hat{x}}^{y} ) + d ( x , {\hat{x}}^{\tilde{y}} ) \qquad Eq . 8$$

where L_{rec} is reconstruction loss 160LR, \hat{x}^{y} and \grave{x}^{\grave{y}} are given in Eq. 5.
   In addition to the reconstruction loss, system 10 may use additional constraints on the reconstruction to enhance results. Specifically, there may be challenges in reproducing areas with significant differences between classes. To address this, system 10 may incorporate an additional constraint for reconstruction between pixels with high amplitude in the distinction branch (ψ₁). High amplitude may signify differences between classes due to the additive nature of the model. The class-distinct reconstruction loss 160CDL may be expressed as in Eq. 9, below:

$${L}_{dis - rec} = d ( x ⊙ 𝕀 , {\hat{x}}^{y} ⊙ 𝕀 ) \qquad Eq . 9$$

where II is an indicator function defined as:

$$𝕀 = \{ \begin{matrix}1 & if \vert {ψ}_{1}^{y} \vert > mean ( \vert {ψ}_{1}^{y} \vert ) \\ 0 & else\end{matrix} )$$

and ⊙ denotes element-wise product. The indicator function [symbol] may select pixels where the absolute value of the class-distinct image component ψ₁^{y} exceeds the mean of |ψ₁^{y}|, thereby focusing the additional reconstruction constraint on regions that exhibit significant class distinctions.

In other words, calculating the class-distinct reconstruction loss 160CDL may include generating a mask (e.g., indicator function [symbol] ) consisting of pixels where an absolute value of the class-distinct image component ψ₁^{y} exceeds a mean absolute value of the class-distinct image component ψ₁^{y}.

The mask may thereby focus the additional reconstruction constraint on regions that exhibit significant class distinctions. The class-distinct reconstruction loss 160CDL may then be calculated based on a distance measure between (i) an element-wise product of the target image 20 (x) and the mask [symbol] , and (ii) an element-wise product of the reproduced target image 30 (\hat{x}^{y}) and the mask [symbol] .

Adversarial loss 160LA: In a GAN-based architecture, discriminator 150 may ensure the quality of generated image components and may have classification capabilities. System 10 may incorporate an adversarial loss to ensure that generators 110 produce image components resembling real ones for a given class. The adversarial loss may be expressed as in Eq. 10, below:

$${L}_{adv} = {E}_{x , y} [ log {D}_{y} ( {x}^{y} ) ] + {E}_{x , \tilde{y}} [ log ( 1 - {D}_{\tilde{y}} ( {\hat{x}}^{\tilde{y}} ) ) ] \qquad Eq . 10$$

where Ladv is the adversarial loss (160LA) and D_{y} represents the γ′th element of a vector of length c, which is an output of discriminator 150. The role of the adversarial loss is to ensure that generators 110 produce image components resembling real ones, for a given class.

According to some embodiments, the adversarial loss 160LA may be generated by applying the multi-head discriminator 150 (FIGS. 2A and 2B). The multi-head discriminator 150 may be configured to receive generated image components from the first generative model 110A and the one or more second generative models 110B.

For one or more (e.g., each) received image component (e.g., class-distinct image component ψ₁ or class-agnostic image components ψᵢ, i=2, . . . , n), the multi-head discriminator 150 may produce a vector having a length corresponding to a number of classes. Each element of the vector may represent an authenticity grade indicating whether the image component is real or fake with respect to a respective class. The multi-head discriminator 150 may calculate the adversarial loss based on the authenticity grades. The adversarial loss may encourage the generative models 110 to produce realistic image components that resemble authentic images for their respective classes.

The total loss 160L (e.g., 160LT) may be a combination (e.g., a weighted sum) of the mentioned losses, and may, for example, be expressed as in Eq. 11, below:

$${L}_{Total} = {λ}_{adv} \cdot {L}_{adv} + {λ}_{cf} \cdot {L}_{class - fake} + {λ}_{rec} \cdot {L}_{rec} + {λ}_{dr} \cdot {L}_{dis - rec} \qquad Eq . 11$$

where L_{Total} is the total loss function value (160LT) used to train the generative models; L_{adv} (160LA) is the adversarial loss, which ensures that generators 110 produce images resembling real ones for a given class; L_{class-fake} is the classification loss (160LC), which enables generators 110 to produce images that correspond to the classifier's predictions. L_{rec} is the reconstruction loss (160LR), which ensures that the generated images approximate a reconstruction of the input image, based on a fidelity measure using L¹ and L²-norms; L_{dis-rec} is the class-distinct reconstruction loss (160CDL), which enhances reconstruction quality in regions with significant class distinctions by incorporating additional constraints for reconstruction between pixels with high amplitude in the distinction branch. weights λ_{adv}, λ_{cf}, λ_{rec}, and λ_{dr} are respective weighting coefficients that may be adjusted based on application requirements.

Weights λ_{adv}, λ_{cf}, λ_{rec}, and λ_{dr} may be adjusted based on application requirements. For applications where good reconstruction is required, the weights for reconstruction may be increased. When style transition is challenging and there are more hidden characteristics, the weights for classification and adversarial loss may be increased.

As explained herein, system 10 (e.g., processor 2 of FIG. 1) may train generative model G1 and the one or more second generative models {G2, . . . , GN} using a combination (e.g., a weighted sum) of loss function values 160L (e.g., L_{Total}) from loss computation module 160. For example, the combination of loss function values 160L may include a value of classification loss 160LC, adapted to align the reproduced 30 target image with the classifier's predictions, and/or a value of reconstruction loss 160LR, adapted to ensure the reproduced version 30 of target image 20 approximates the target image 20.

Additionally, or alternatively, the combination of loss function values 160L may further include a value of adversarial loss 160LA, adapted to ensure generation of realistic image components by the generative models 110 and/or a value of class-distinct reconstruction loss 160CDL, adapted to enhance reconstruction quality of the reproduced version 30 of target image 20 in regions with significant class distinctions.

DXAI and zero distinction: Let us see how the training process and losses above approximate the DXAI problem. The reconstruction loss promotes x≈\hat{x}^{y}≈\grave{x}^{\grave{y}}. The classification loss promotes that \grave{x}^{\grave{y}} belongs to class \grave{y}≠y.

Thus, the shared image components

$${ψ}_{i}^{y} = {ψ}_{i}^{{y}^{′}} , i = 2 , … n ,$$

should belong to the class-agnostic part. The effects of branch specialization, as shown in Eq. 6, encourage each image component ψi to contain different image characteristics. Since class \grave{y} is random, following Eq. 4, we get that the class-agnostic image component ψ_{Agnostic} is not committed to any specific class.

In addition, we chose to set the class-distinct image component

$${ψ}_{1}^{{y}^{′}} = 0$$

in Eq. 5. This is in line with the DXAI formulation, Eq. 2. We would like to choose the agnostic image component which is closest to the input image. We explain below additional benefits of this setting. Since our algorithm is of additive nature, it can offer two types of explanations. The more intuitive approach is to highlight unique class features positively, effectively adding distinctiveness to an image with neutral attributes. This ensures the appearance of the differences in the distinction map 30.

Alternatively, it is possible also to subtract distinct features. Negative explanations are less preferred, since they are less intuitive for class explanation. For example, when classifier 130 predicts whether an image contains cars, we prefer to receive an image of cars in the class-distinct image component \Distinct, rather than a subtraction when it predicts the absence of cars.

Setting the class-distinct image component of an alternative class to zero may diminish negative explanations. Moreover, due to reconstruction demands, the network strives to produce as realistic images as possible by the alternative generators, reducing spurious features and undesired details in the class-distinct image component. This is because even with the map reset, the remaining class-agnostic image 30B must closely resemble the original image, which forces the map to omit unnecessary details not required to explain class identity.

According to some embodiments, system 10 (e.g., processor 2 of FIG. 1) may train the first generative model 110A (G₁) and the one or more second generative models 110B (G₂ . . . G_{N}) as follows. Referring to FIGS. 2A and 2B, system 10 may receive a batch of training images 20 from input dataset 20DS. For each batch, system 10 may randomly select a weight vector α, having entries corresponding to respective generative models of the one or more second generative models 110B (G₂ . . . G_{N}). According to some embodiments, each element of the weight vector α may be uniformly distributed in the range [0, 1].

For one or more training images x^{y} 20 in the batch, system 10 may calculate a respective pair of interim images 30 (\grave{x}^{\grave{y}}, \hat{x}^{y}) based on the weight vector α. As shown in Eq. 5, a first interim image 30 (\hat{x}^{y}) of the pair of interim images may represent a reproduction of the respective training image that emphasizes the predicted class y, and a second interim image \grave{x}^{\grave{y}} of the pair of interim images may represent a reproduction of the respective training image that emphasizes an alternative class \grave{y}, different from the predicted class y.

As explained herein (e.g., in relation to Eq. 5), system 10 may calculate the first interim image 30 (\hat{x}^{y}) as a weighted sum of (a) a class-distinct image component (ψ₁^{y}) of the respective training image, representing the predicted class, generated by the first generative model G₁ 110A, (b) class-agnostic image components (ψᵢ^{y}, i=2, . . . , n) of the respective training image, generated by the one or more second generative models 110B (G₂, . . . , G_{N}), representing the predicted class, weighted according to the weight vector α, and (c) class-agnostic image 30B components (ψᵢ^{\tilde{y}}, i=2, . . . , n) of the respective training image, generated by the one or more second generative models 110B (G₂, . . . , G_{N}), representing the alternative class, weighted according to (1−α).

Additionally, or alternatively, system 10 may calculate the second interim image as a weighted sum of (a) a class-distinct image component (ψ₁^{\tilde{y}}) of the respective training image, representing the alternative class, generated by the first generative model G₁ 110A, (b) class-agnostic image components (ψᵢ^{\tilde{y}}, i=2, . . . , n) of the respective training image, generated by the one or more second generative models (G₂, . . . , G_{N}) 110B, representing the alternative class, weighted according to the weight vector α, and (c) class-agnostic image 30B components (ψᵢ^{y}, i=2, . . . , n) of the respective training image, generated by the one or more second generative models (G₂, . . . , G_{N}) 110B, representing the predicted class, weighted according to (1−α).

Loss computation module 160 may calculate the combination of loss function values 160L (e.g., 160LT) based on the pairs of interim images 30 (\grave{x}^{\grave{y}},\hat{x}^{y}). For example, reconstruction loss 160LR may be calculated based on a distance measure between the interim images (\grave{x}^{\grave{y}}, \hat{x}^{y}) and the original training image x, thereby ensuring that both interim images approximate the original training image. Classification loss 160LC may be calculated based on predictions by classifier 130 for the interim images, thereby ensuring that the first interim image \hat{x}^{y} is classified as the predicted class y and the second interim image \grave{x}^{\grave{y}} is classified as the alternative class \grave{y}.

System 10 may modify weights of at least one of the first generative model 110A (G₁) and the one or more second generative models 110B (G₂, . . . , G_{N}) based on the combination of loss function values. For example, system 10 may modify the weights by minimizing the combined loss value 160L using optimization techniques such as gradient descent or backward propagation. System 10 may thereby train the generative models to produce class-distinct image components.

The inventors examined the impact of the number of branches (generative models 110) on the quality of the decomposition. The inventors have observed that while the decomposition may focuse on two main image components (class-distinct 30A and class-agnostic 30B), using more than two generative models 110 for the solution may provide improved results. Using multiple branches for the class-agnostic part may result in better reconstruction quality and improved ability of the generators 110 to produce images that explain the classifier 130. For example, the inventors have observed that reconstruction quality metrics such as Peak Signal-to-Noise Ratio (PSNR) may decrease when using only two branches. Additionally, the classification loss representing the generators' 110 ability to produce meaningful images of a specific class may be higher when using only two branches, meaning the classifier 130 may interpret the images less accurately as the desired class.

As explained herein, the training process may encourage the one or more second generative models 110B (G₂, . . . , G_{N}) to generate substantially identical image components 30A (ψᵢ^{y}, i=2, . . . , n) and 30B (ψᵢ^{\tilde{y}}, i=2, . . . , n) for both the predicted class and the alternative class, thereby isolating distinctive features between the predicted class y and the alternative class \grave{y} to the first generative model 110A (G₁).

In the inference stage, system 10 may utilize an input image x (20) belonging to class y, denoted as x^{y}. Classifier 130 may predict the class of x as y or ŷ. To explain and clarify this classification outcome, system 10 may leverage the trained DXAI model. The generators 110 may generate image components according to the given classification. The first branch (e.g., generator 110A) may yield the class-distinct (CD) image component 30A, showcasing the components of target image 20 that contribute to class interpretation 130C. The sum of outputs of the other branches, image components 30B of generators 110B, may be aggregated to produce the class-agnostic part ψ_{Agnostic} of target image 20.

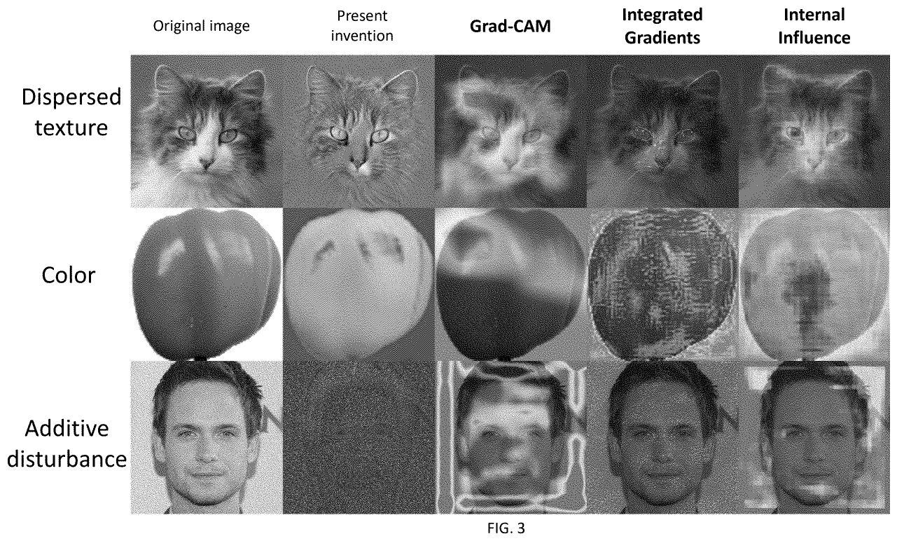

Reference is now made to FIG. 3, which is a table of images, showing examples of producing explainable image classifications, by embodiments of the invention, and by other, currently available methods, in three different scenarios.

The leftmost column shown original images in each of the three scenarios: e.g., depicting a cat, a pepper, and a human face.

The effect of embodiments of the invention are shown in the second column of FIG. 3, whereas three other heatmap solutions (Grad-CAM, Integrated gradients and Internal influence) are depicted in the following columns. It may be appreciated that heatmap-based methods are less informative, due to the following reasons:

As shown on the top row, many details spread across large portions of the image. These details are helpful for accurate classification, while heatmaps show only partial relevant information.

As shown on the second row, distinguishing between types of objects (e.g., peppers) that differ mainly by color, may not be explicable using heatmaps.

The bottom row depicts detection of additive statistical disturbance (e.g., using a class of clean images and a class of images with noise). Since the contribution is global—heatmaps typically face difficulties explaining the reason for classification.

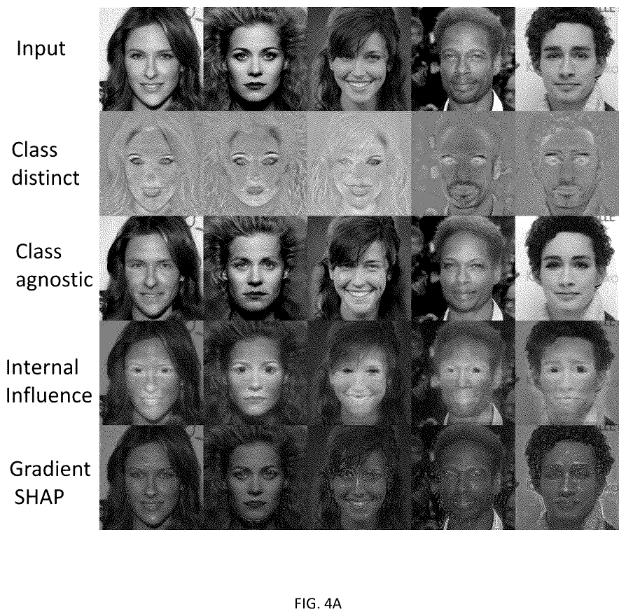

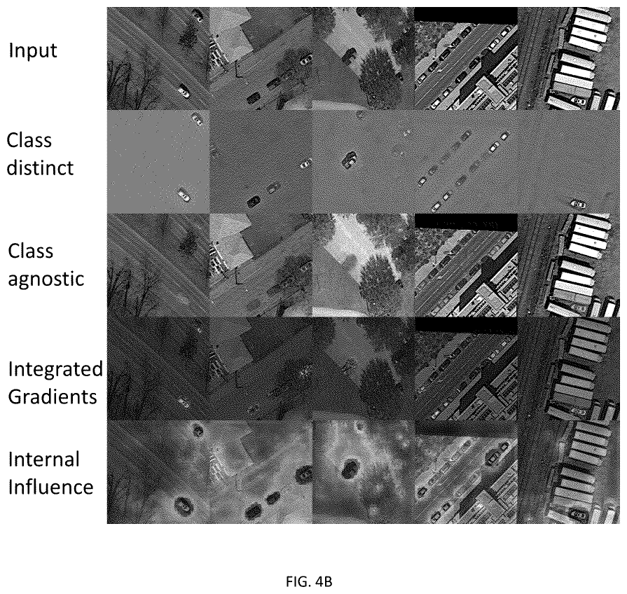

Reference is now made to FIGS. 4A and 4B which are tables of images showing examples of producing explainable image classifications by embodiments of the invention, using class-distinctive and class-agnostic images, alongside other, currently available methods of explainable image classifications.

In FIG. 4A, classification of facial images (top row) according to male and female classification category was explored.

The second and third rows pertain to the present invention: The second row includes respective class-distinctive images 30A \hat{x}^{y}, showing an explanation of features that classifier 130 found indicative of male or female characteristics. The third row represents class-agnostic images 30B \grave{x}^{\grave{y}}, showing an explanation of features that classifier 130 found neutral to the classification of a face as either male or female.

The fourth and fifth rows depict results obtained from other, heatmap-based methods of XAI, namely “internal influence” and “Gradient SHAP”. It may be visibly appreciated that the heatmap results are less informative than those provided by embodiments of the present invention.

In FIG. 4B, classification of aerial photographs (top row) according to a classification criterion of existence of cars was explored.

The second and third rows pertain to the present invention: The second row represents respective class-distinctive images 30A \hat{x}^{y}, showing an explanation of features that classifier 130 found indicative of cars. The third row represents class-agnostic images 30B \grave{x}^{\grave{y}}, showing an explanation of features that classifier 130 found neutral to the classification of cars either being depicted or not in the input images.

The fourth and fifth rows depict results obtained from other, heatmap-based methods of XAI, namely “Integrated gradient” and “internal influence”. It may be visibly appreciated that the heatmap results are less informative than those provided by embodiments of the present invention.

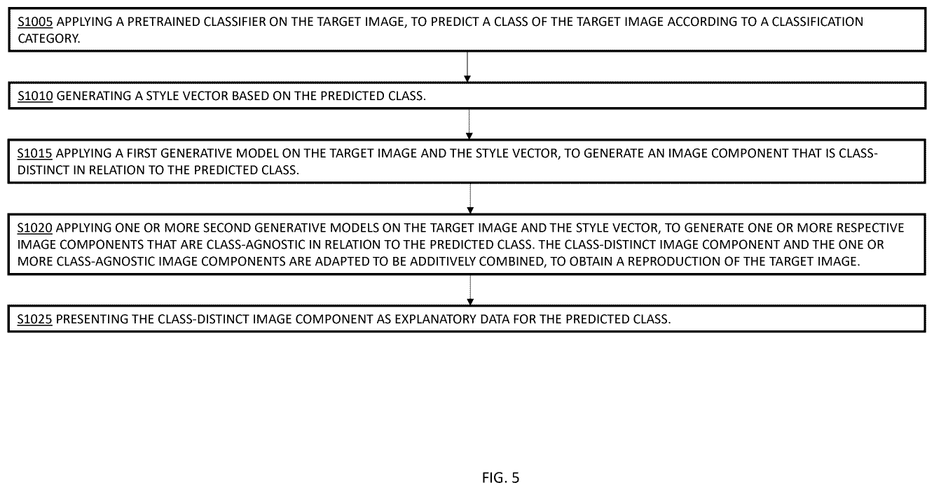

Reference is now made to FIG. 5 which is a flow diagram, depicting a method of explainable classification of a target image by at least one processor, according to some embodiments of the invention.

As shown in step S1005, at least one processor (e.g., processor 2 of FIG. 1) may apply a pretrained classifier (e.g., 130 of FIGS. 2A/2B) on the target image (e.g., 20 x^{y} of FIG. 2A) to predict a class (e.g., 130C of FIG. 2A/2B) of target image 20 according to a classification category.

As shown in step S1010, the at least one processor 2 may generate a style vector (e.g., 140S of FIGS. 2A/2B) based on the predicted class.

As shown in step S1015, the at least one processor 2 may apply a first generative model (e.g., 110A (G₁) of FIGS. 2A/2B) on target image 20 and the style vector 140S, to generate an image component that is class-distinct (e.g., 30A of FIG. 2, also referred to as ψ₁^{\grave{y}}) in relation to the predicted class.

As shown in step S1020, the at least one processor 2 may apply one or more second generative models (e.g., 110B (G₂ . . . . G_{N}) of FIGS. 2A/2B) on target image 20 and the style vector 140S, to generate one or more respective image components

$$( e . g . , {ψ}_{2}^{{y}^{′}} … {ψ}_{N}^{{y}^{′}} of Figs . 2 A / 2 B )$$

that are class-agnostic in relation to the predicted class. The class-distinct image component and the one or more class-agnostic image components may be adapted to be additively combined

$$( e . g . , {ψ}_{1}^{{y}^{′}} + {ψ}_{2}^{{y}^{′}} + ⋯ + {ψ}_{N}^{{y}^{′}} ) ,$$

to obtain a reproduction (\hat{x}^{y}) of the target image (20 x^{y}).

As shown in step S1025, the at least one processor 2 may subsequently present the class-distinct image component as explanatory data for the predicted class, intuitively understood by human operators.

According to some embodiments, system 10 (e.g., processor 2) may present the class-distinct image component 30A as explanatory data for the predicted class 130C in various ways. The presentation may be manifested on computing device 1 of FIG. 1, for example using output device 8 to display visual information and/or input device 7 to receive user commands for controlling the presentation.

In some embodiments, presenting the class-distinct image component 30A as explanatory data may comprise displaying the class-distinct image component 30A separately from the target image 20 to highlight features that contribute to the predicted class 130C. For example, the class-distinct image component 30A may be shown in a dedicated window or display region on output device 8, allowing a user to examine the distinctive features in isolation.

Additionally, or alternatively, presenting the class-distinct image component 30A as explanatory data may comprise overlaying the class-distinct image component 30A on the target image 20 to show spatial correspondence between distinctive features and the original image. For example, output device 8 may display a composite view where the class-distinct image component 30A is superimposed on the target image 20, enabling a user to see precisely where the distinctive features are located within the original image context.

Additionally, or alternatively, presenting the class-distinct image component 30A as explanatory data may comprise displaying the class-distinct image component 30A alongside the one or more class-agnostic image components 30B to demonstrate the decomposition of the target image 20. For example, output device 8 may present a side-by-side view showing the class-distinct image component 30A and the class-agnostic image components 30B, allowing a user to understand how the target image 20 has been partitioned into its constituent parts.

Additionally, or alternatively, presenting the class-distinct image component 30A as explanatory data may comprise providing the class-distinct image component 30A as a visual explanation that shows which image features led to the predicted class 130C. For example, the class-distinct image component 30A may be presented with annotations or labels on output device 8, indicating the relationship between the displayed features and the classification decision made by classifier 130.

Additionally, or alternatively, presenting the class-distinct image component 30A as explanatory data may comprise outputting the class-distinct image component 30A in a format suitable for user interpretation of the classification decision. For example, the class-distinct image component 30A may be stored in storage system 6 in a standard image format, transmitted to an external system via input/output devices 7 and 8, or rendered on output device 8 in a manner that facilitates human understanding of why classifier 130 predicted the particular class 130C.

The present invention provides a practical application in the technological field of machine learning-based image classification by enabling users to understand and interpret the reasoning behind neural network classification decisions. Rather than producing abstract heatmaps that merely indicate pixel importance, embodiments of the invention generate actual image components that can be visually inspected and intuitively understood by human operators. This practical application may be particularly valuable in domains where classification decisions have significant consequences, such as medical imaging, autonomous vehicle perception, security screening, and quality control systems.

The decomposition of images into class-distinct and class-agnostic image components provides actionable information that may assist practitioners in validating classifier behavior, identifying potential biases in training data, debugging classification errors, and building trust in automated decision-making systems. For example, in medical imaging applications, a radiologist may examine the class-distinct image component to verify that a tumor detection classifier is focusing on clinically relevant features rather than artifacts or spurious correlations.

Embodiments of the present invention provide an improvement in computer technology, specifically in the technical field of explainable artificial intelligence for image classification. The improvement in technology addresses several technical limitations of currently available XAI methods.

For example, embodiments of the invention may provide high-resolution explanations that preserve fine detail, overcoming resolution limitations inherent in methods that calculate importance in spatially coarse internal layers. The generative model approach provided by embodiments of the invention may produce explanations at the same resolution as the input image.

Embodiments of the invention may also provide multi-channel explanations that retain color and texture information, addressing the limitation of currently available solutions that typically produce single-channel, grayscale importance maps. This improvement in technology enables meaningful explanations in scenarios where color or texture information is relevant to the classification decision.

In another example, embodiments of the invention may reduce computational complexity at inference time by eliminating the need for gradient computations, attribution calculations across multiple layers, or numerous perturbation iterations as done by currently available solutions. Once the generative models are trained, embodiments of the invention may perform the decomposition in a single forward pass, making system 10 suitable for real-time applications.

In another example, embodiments of the invention may operate with arbitrary pretrained classifiers without imposing architectural constraints, such as requiring specific activation layers or dedicated architectures designed solely for explainability. This improvement in technology enables embodiments of the invention to explain operation of existing deployed classifiers without modification.

In yet another example, embodiments of the invention may provide dense, global explanations that are effective when classification features are distributed across large portions of the image, when color changes appear throughout the image, or when class distinction is based on global disturbances or statistical changes spanning the entire image domain. Currently available heatmap-based methods may be limited in such scenarios, either focusing too narrowly on dominant features or showing large uniform areas that provide limited insight into the classification decision.

A number of implementations have been described. Nevertheless, it will be understood that various modifications may be made without departing from the spirit and scope of the disclosure. Accordingly, other implementations are within the scope of the following claims.

1. A method of explainable classification of a target image by at least one processor, the method comprising:
applying a pretrained classifier on the target image, to predict a class of the target image according to a classification category;
generating a style vector based on the predicted class;
applying a first generative model on the target image and the style vector, to generate an image component that is class-distinct in relation to the predicted class;
applying one or more second generative models on the target image and the style vector, to generate one or more respective image components that are class-agnostic in relation to the predicted class; and
presenting the class-distinct image component as explanatory data for the predicted class, wherein the class-distinct image component and the one or more class-agnostic image components are adapted to be additively combined, to obtain a reproduction of the target image.

2. The method of claim 1, further comprising training the first generative model and the one or more second generative models using a combination of loss function values, selected from a list consisting of: a value of classification loss, adapted to align the reproduced target image with the classifier's predictions, and a value of reconstruction loss, adapted to ensure the reproduced target image approximates the target image.

3. The method of claim 2, wherein the combination of loss function values further comprises a value of adversarial loss, adapted to ensure generation of realistic image components by the generative models.

4. The method of claim 2, wherein the combination of loss function values further comprises a value of class-distinct reconstruction loss, adapted to enhance reconstruction quality of the reproduced target image in regions with significant class distinctions.

5. The method of claim 2, further comprising training the first generative model and one or more second generative models by:
receiving a batch of training images;
randomly selecting a weight vector α, having entries corresponding to respective generative models of the one or more second generative models;
for one or more training images in the batch: (i) calculating a respective pair of interim images based on the weight vector α, and (ii) calculating the combination of loss function values based on the pairs of interim images; and
modifying weights of at least one of the first generative model and the one or more second generative models based on the combination of loss function values.

6. The method of claim 5, wherein a first interim image of the pair of interim images represents a reproduction of the respective training image that emphasizes the predicted class, and wherein a second interim image of the pair of interim images represents reproduction of the respective training image that emphasizes an alternative class, different from the predicted class.

7. The method of claim 6 further comprising calculating the first interim image as a weighted sum of (a) a class-distinct image component of the respective training image, representing the predicted class, generated by the first generative model, (b) class-agnostic image components of the respective training image, generated by the one or more second generative models, representing the predicted class, weighted according to the weight vector α, and (c) class-agnostic image components of the respective training image, generated by the one or more second generative models, representing the alternative class, weighted according to (1−α).

8. The method of claim 6 further comprising calculating the second interim image as a weighted sum of (a) a class-distinct image component of the respective training image, representing the alternative class, generated by the first generative model, (b) class-agnostic image components of the respective training image, generated by the one or more second generative models, representing the alternative class, weighted according to the weight vector α, and (c) class-agnostic image components of the respective training image, generated by the one or more second generative models, representing the predicted class, weighted according to (1−α).

9. The method of claim 6, wherein training the first generative model and one or more second generative models further comprises encouraging the one or more second generative models to generate substantially identical image components for both the predicted class and the alternative class, thereby isolating distinctive features between the predicted class and the alternative class to the first generative model.

10. The method of claim 1, further comprising:
obtaining a mapping network, configured to encode class-specific characteristics as style representation vectors;
applying the mapping network on the predicted class; and
generating the style vector based on output of the mapping network.

11. The method of claim 3, wherein the adversarial loss is generated by applying a multi-head discriminator configured to:
receive generated image components from the first generative model and the one or more second generative models;
produce, for each received image component, a vector having a length corresponding to a number of classes, wherein each element represents an authenticity grade indicating whether the image component is real or fake with respect to a respective class; and
calculate the adversarial loss based on the authenticity grades to encourage the generative models to produce realistic image components that resemble authentic images for their respective classes.

12. The method of claim 4, wherein calculating the class-distinct reconstruction loss comprises:
generating a mask consisting of pixels where an absolute value of the class-distinct image component exceeds a mean absolute value of the class-distinct image component; and
computing the class-distinct reconstruction loss based on a distance measure between (i) an element-wise product of the target image and the mask, and (ii) an element-wise product of the reproduced target image and the mask.

13. The method of claim 1, wherein presenting the class-distinct image component as explanatory data comprises at least one of:
displaying the class-distinct image component separately from the target image to highlight features that contribute to the predicted class;
overlaying the class-distinct image component on the target image to show spatial correspondence between distinctive features and the target image;
displaying the class-distinct image component alongside the one or more class-agnostic image components to demonstrate a decomposition of the target image;
providing the class-distinct image component as a visual explanation that shows which image features led to the predicted class; and
outputting the class-distinct image component in a format suitable for user interpretation of a classification decision.

14. The method of claim 1, wherein the classifier is pretrained by:
receiving a labeled dataset comprising training images and corresponding class labels;
processing the training images through the classifier to obtain predicted class probabilities;
calculating a classification loss based on the predicted class probabilities and the corresponding class labels; and
adjusting weights of the classifier based on the classification loss.

15. A system for explainable classification of a target image, the system comprising: a non-transitory memory device, wherein modules of instruction code are stored, and at least one processor associated with the memory device, and configured to execute the modules of instruction code, whereupon execution of said modules of instruction code, the at least one processor is configured to:
apply a pretrained classifier on the target image, to predict a class of the target image according to a classification category;
generate a style vector based on the predicted class;
apply a first generative model on the target image and the style vector, to generate an image component that is class-distinct in relation to the predicted class;
apply one or more second generative models on the target image and the style vector, to generate one or more respective image components that are class-agnostic in relation to the predicted class; and
present the class-distinct image component as explanatory data for the predicted class, wherein the class-distinct image component and the one or more class-agnostic image components are adapted to be additively combined, to obtain a reproduction of the target image.

16. The system of claim 15, wherein the at least one processor is further configured to train the first generative model and the one or more second generative models using a combination of loss function values, selected from a list consisting of: a value of classification loss, adapted to align the reproduced target image with the classifier's predictions, and a value of reconstruction loss, adapted to ensure the reproduced target image approximates the target image.

17. The system of claim 16, wherein the at least one processor is further configured to train the first generative model and one or more second generative models by:
receiving a batch of training images;
randomly selecting a weight vector α, having entries corresponding to respective generative models of the one or more second generative models;
for one or more training images in the batch: (i) calculating a respective pair of interim images based on the weight vector α, and (ii) calculating the combination of loss function values based on the pairs of interim images; and
modifying weights of at least one of the first generative model and the one or more second generative models based on the combination of loss function values.

18. The system of claim 17, wherein a first interim image of the pair of interim images represents a reproduction of a respective training image that emphasizes the predicted class, and wherein a second interim image of the pair of interim images represents reproduction of the respective training image that emphasizes an alternative class, different from the predicted class.

19. The system of claim 18, wherein the at least one processor is configured to calculate the first interim image as a weighted sum, according to the weight vector α, of (a) a class-distinct image component of the respective training image, representing the predicted class, generated by the first generative model, (b) class-agnostic image components of the respective training image, generated by the one or more second generative models, representing the predicted class, and (c) class-agnostic image components of the respective training image, generated by the one or more second generative models, representing the alternative class.

20. The system of claim 18, wherein the at least one processor is configured to calculate the second interim image as a weighted sum, according to the weight vector α, of (a) a class-distinct image component of the respective training image, representing the alternative class, generated by the first generative model, (b) class-agnostic image components of the respective training image, generated by the one or more second generative models, representing the alternative class, and (c) class-agnostic image components of the respective training image, generated by the one or more second generative models, representing the predicted class.
